(19) United States
(12) Patent Application Publication
(10) Pub. No.: US 2012/0049677 A1
(43) Pub. Date: Mar. 1, 2012

(54) Motor

(75) Inventor: Chang Jo Yu, Suwon (KR)

(73) Assignee: SAMSUNG ELECTRO-MECHANICS CO., LTD., Suwon (KR)

(21) Appl. No.: 12/929,336

(22) Filed: Jan. 14, 2011

(30) Foreign Application Priority Data
Sep. 1, 2010 (KR) 10-2010-0085692

(51) Int. Cl. H02K 7/08

(52) U.S. Cl. 310/90

(57) ABSTRACT

There is provided a motor including: a fixing member inserted with a shaft and supporting the rotation of the shaft; a rotating member rotating while interworking with the shaft; a stopper part formed on one of the fixing member and the rotating member to prevent the rotating member from floating; an anti-floating part formed on the other one of the fixing member and the rotating member and interfering with the stopper part to prevent the rotating member from floating; and a leakage preventing part sealing oil between the stopper part and the anti-floating part and formed to be protruded on at least one of the stopper part and the anti-floating part to minimize an oil sealing gap between the stopper part and the anti-floating part.

### CROSS-REFERENCE TO RELATED APPLICATIONS

This application claims the priority of Korean Patent Application No. 10-2010-0085692 filed on Sep. 1, 2010, in the Korean Intellectual Property Office, the disclosure of which is incorporated herein by reference.

### BACKGROUND OF THE INVENTION

1. Field of the Invention

The present invention relates to a motor, and more particularly, to a motor with improved impact resistance and vibration resistance.

2. Description of the Related Art

As an information storage device, a hard disk drive (HDD) is a device that uses a read/write head to reproduce data stored on a disk or record data thereon.

The hard disk drive requires a disk driving device capable of driving a disk. To this end, a small spindle motor is used as the disk driving device.

The small spindle motor uses a fluid dynamic bearing assembly. In the fluid dynamic bearing assembly, oil is filled between one of rotating members, a shaft, and one of fixing members, a sleeve. The shaft is supported by a fluid pressure generated from the oil.

In addition, the oil filled between the rotating member and the fixing member of the spindle motor is sealed. The oil sealing is made by using a capillary phenomenon and the surface tension of oil.

In the spindle motor adopting the fluid dynamic bearing assembly and the sealing structure of oil, it is important to prevent the sealed oil from being leaked when an impact or vibrations are applied to the spindle motor.

When the oil sealed by the impact or the vibrations is leaked, noise, vibrations, Non-Repeatable Run-Out (NRRO), or the like, are generated when the motor is rotated at high speed, which has a negative effect on the lifespan of the motor.

Therefore, even though an impact or vibrations is applied to the spindle motor, there is a need to suppress the movement of the rotating members, thereby preventing the interface with the sealed oil from moving.

As a result, a method of improving the characteristics and lifespan of the motor by preventing the leakage of the sealed oil due to the impact or the vibration is needed.

### SUMMARY OF THE INVENTION

An aspect of the present invention provides a motor capable of controlling a gap between a rotating member and a fixing member or between a stopper part and an anti-floating part to improve impact resistance and vibration resistance and being driven with low current to improve the performance and lifespan of the motor.

According to an aspect of the present invention, there is provided a motor including: a fixing member inserted with a shaft and supporting the rotation of the shaft; a rotating member rotating while interworking with the shaft; a stopper part formed on one of the fixing member and the rotating member to prevent the rotating member from floating; an anti-floating part formed on the other one of the fixing member and the rotating member and interfering with the stopper part to prevent the rotating member from floating; and a leakage preventing part sealing oil between the stopper part and the anti-floating part and formed to be protruded on at least one of the stopper part and the anti-floating part to minimize an oil sealing gap between the stopper part and the anti-floating part.

One surface of the stopper part or the anti-floating part formed with the leakage preventing part may be a plane stepped from one end of the leakage preventing part toward the interfacial direction of oil.

One surface of the stopper part or the anti-floating part formed with the leakage preventing part may be formed to be tapered to include the oil sealing gap increased from one end of the leakage preventing part toward the interfacial direction of oil.

A pumping groove pumping the oil from the oil interface toward the leakage preventing part may be formed between the oil interface and the leakage preventing part on one surface of the stopper part or the anti-floating part formed with the leakage preventing part.

The pumping groove may be formed in at least one of a spiral shape or a herringbone shape.

According to another aspect of the present invention, there is provided a motor, including: a sleeve supporting a shaft to protrude the top end of the shaft upward in a shaft direction; a rotating member rotating, while interworking with the shaft; a thrust plate combined with the shaft protruded upward in the shaft direction of the sleeve to provide a thrust dynamic pressure; a cap member combined with the sleeve on the top portion of the thrust plate to seal oil between the cap member and the thrust plate; and a leakage preventing part sealing oil between the thrust plate and the cap member and formed to be protruded on at least one of the thrust plate and the cap member to minimize the oil sealing gap between the thrust plate and the cap member.

One surface of the thrust plate or the cap member formed with the leakage preventing part may be a plane stepped from one end of the leakage preventing part toward the interfacial direction of oil.

One surface of the thrust plate or the cap member formed with the leakage preventing part may be formed to be tapered to include the oil sealing gap increased from one end of the leakage preventing part toward the interfacial direction of the oil.

A pumping groove pumping the oil from the oil interface toward the leakage preventing part may be formed between the oil interface and the leakage preventing part on one surface of the thrust plate or the cap member formed with the leakage preventing part.

The pumping groove may be formed in at least one of a spiral shape or a herringbone shape.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a motor according to an exemplary embodiment of the present invention;

FIG. 2 is a cross-sectional view schematically showing a fluid dynamic bearing assembly provided in the motor according to the exemplary embodiment of the present invention;

FIG. 3 is an enlarged view of A of FIG. 2 according to another exemplary embodiment;

FIGS. 4 and 5 are schematic bottom views of a cap member for showing a pumping groove of the cap member provided in the motor according to the exemplary embodiment of the present invention;

FIG. 6 is a cross-sectional view schematically showing the motor according to another exemplary embodiment of the present invention; and

FIG. 7 is an enlarged view of B of FIG. 6 according to another exemplary embodiment.

### DETAILED DESCRIPTION OF THE PREFERRED EMBODIMENT

Exemplary embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit, but those are construed as being included in the spirit of the present invention.

Further, like reference numerals will be used to designate like components having similar functions throughout the drawings within the scope of the present invention.

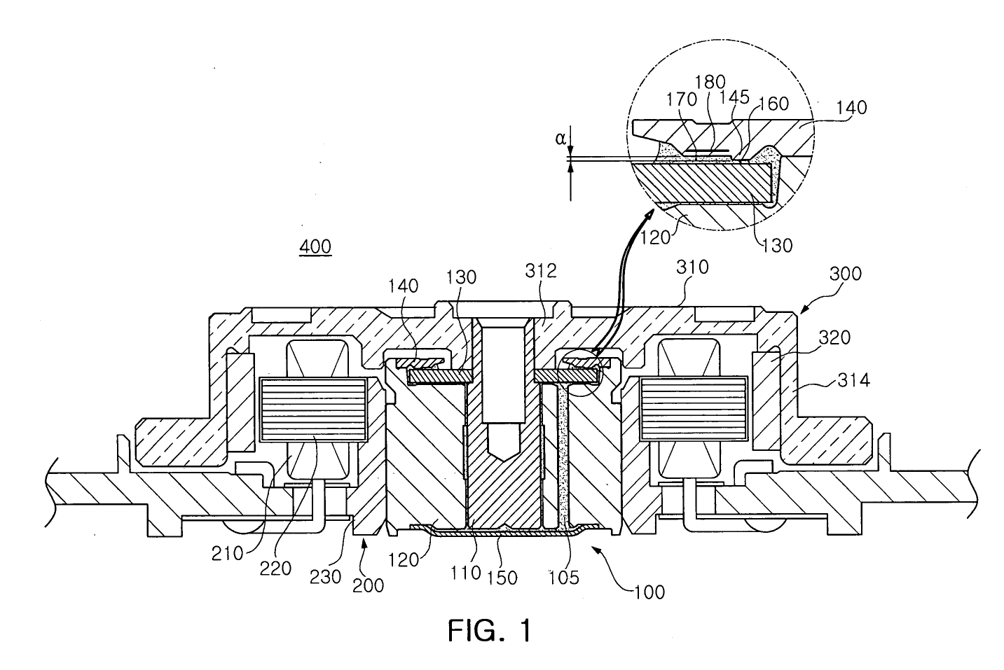

FIG. 1 is a cross-sectional view schematically showing a motor according to an exemplary embodiment of the present invention.

Referring to FIG. 1, a motor 400 according to an exemplary embodiment of the present invention may be configured to include a fluid dynamic bearing assembly 100, a fixing member 200, and a rotating member 300.

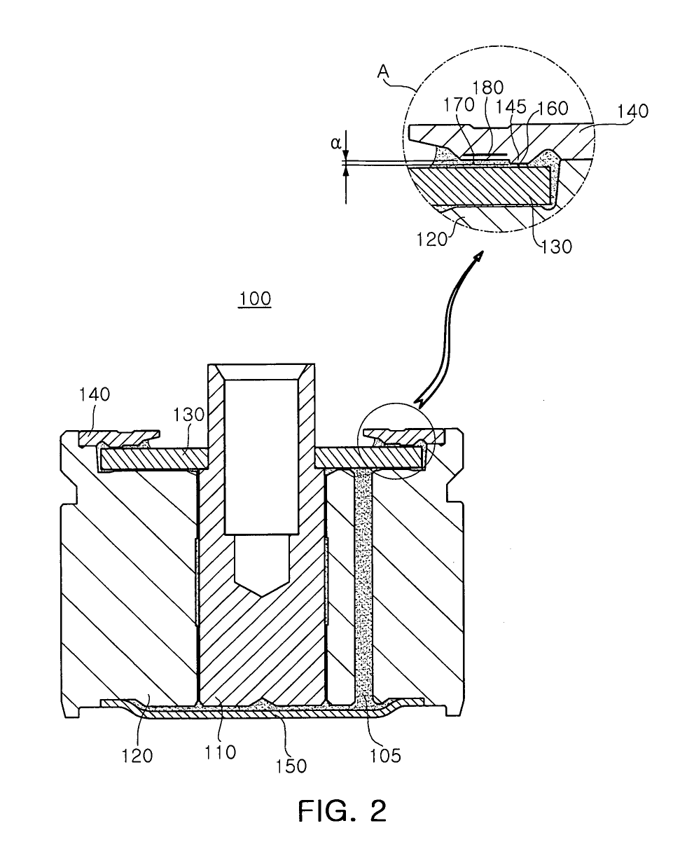

First, terms with relation to direction are defined. An axial direction means a vertical direction based on a shaft 110 when viewed in FIGS. 1 and 2, while an outer-diameter direction or an inner-diameter direction means an outer end direction of a rotor case 310 based on the shaft 110 or a central direction of the shaft 11, based on the outer edge of the rotor case 310.

The fluid dynamic bearing assembly 100 may be configured to include a shaft 110, a sleeve 120, a thrust plate 130, a cap member 140, and a base cover 150, wherein the shaft 110 and the thrust plate 130 may be included in the rotating members 300 and other components may be included in the fixing members 200.

In this configuration, the fluid dynamic bearing assembly 100 will be described in detail with reference to FIG. 2 and components not included in the fluid dynamic bearing assembly 100 among the fixing members 200 and the rotating members 300 will be described.

The fixing member 200 may include a coil 210, a core 220, and a base 230.

In other words, the fixing member 200 may be a fixing structure that includes a coil 210 generating an electromagnetic force having a predetermined magnitude when power is applied thereto and a plurality of cores 220 wound with the coil 210.

The core 220 is fixedly disposed on the top portion of the base 230 on which a printed circuit board (not shown) printed with pattern circuits is provided and a plurality of coil holes having a predetermined size may be formed, penetrating through the top surface of the base 230 corresponding to the winding coil 210, in order to expose the winding coil 210 downward, wherein the winding coil 210 is electrically connected to the printed circuit board (not shown) in order to supply external power thereto.

The base 230 may be press-fitted in the outer peripheral surface of the sleeve 120 to be described below and the core 220 wound with the coil 210 may be inserted thereinto. Meanwhile, the base 230 and the sleeve 120 may be assembled by applying an adhesive on the inner surface of the base 230 or the outer surface of the sleeve 120.

The rotating member 300 is a rotating structure rotatably provided with respect to the fixing member 200 and may include a rotor case 310 of which the outer peripheral surface is provided with an annular ring magnet 320 corresponding to the core 220 at a predetermined distance.

The magnet 320 is a permanent magnet generating a magnetic force of a predetermined intensity by alternately magnetizing an N pole and an S pole thereof in a circumferential direction.

In this case, the rotor case 310 may be configured to include a hub base 312 fixed by being press-fitted in the top end of the shaft 110 and a magnet supporting part 314 extending in the outer-diameter direction from the hub base 312 and bent downward in a shaft direction to support the magnet 320.

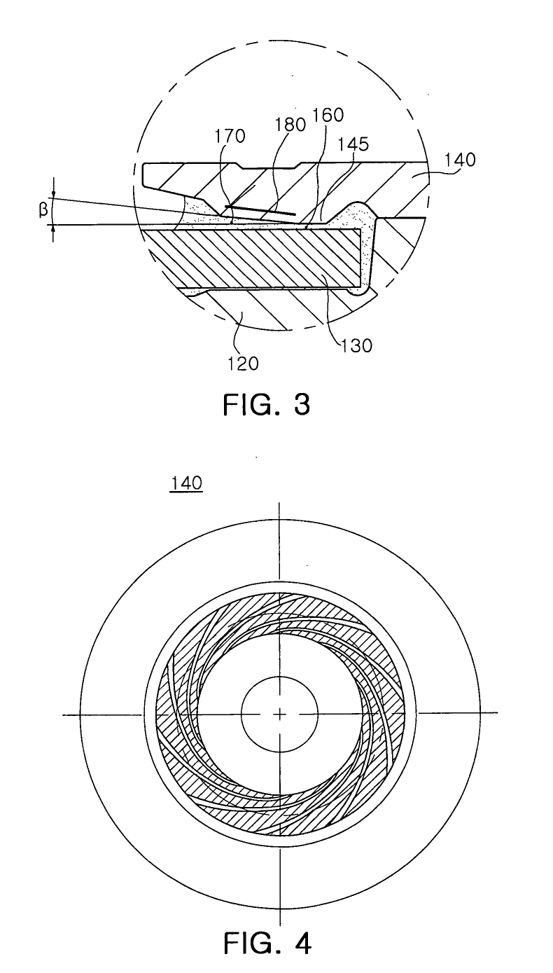

FIG. 2 is a cross-sectional view schematically showing a fluid dynamic bearing assembly provided in the motor according to the exemplary embodiment of the present invention and FIG. 3 is an enlarged view of A of FIG. 2 according to another exemplary embodiment.

Referring to FIG. 2, the fluid dynamic bearing assembly 100 provided in the motor 400 according to an exemplary embodiment of the present invention may be configured to include the shaft 110, the sleeve 120, the thrust plate 130, the cap member, and a leakage preventing part 145.

The sleeve 120 may support the shaft 110 so that the top end of the shaft 110 is protruded upward in a shaft direction and may be formed by forging Cu or Al or sintering Cu—Fe-based alloy powders or SUS-based powders.

In this configuration, the shaft 110 is inserted while having a micro clearance with a shaft hole of the sleeve 120. The micro clearance is filled with oil, which can more smoothly rotate the rotating member 300, i.e., the shaft 110 due to a radial dynamic groove formed in at least one of the outer diameter of the shaft 110 and the inner diameter of the sleeve 120.

The radial dynamic groove is formed in the inner side of the sleeve 120 that is provided on the inside of the shaft hole of the sleeve 120 and forms a pressure so that it is biased to one side when the shaft 110 is rotated.

However, the radial dynamic groove is not limited to the case in which it is provided in the inner side of the sleeve 120 as described above. As a result, it is to be noted that the radial dynamic groove may be provided at the outer side of the shaft 110 and the number thereof is not limited.

The sleeve 120 is provided with a bypass channel 105 formed to communicate the top portion and the bottom portion of the sleeve 120 with each other, which may disperse the pressure of oil in the fluid dynamic bearing assembly 100 so as to maintain the balance and may be moved bubbles, or the like, existing in the fluid dynamic bearing assembly 100 to be discharged by circulation.

In this case, the base cover 150 may be combined with the sleeve 120 downward in a shaft direction of the sleeve 120 in a state in which the clearance therebetween is maintained and the clearance may be combined the base cover 150 to receive oil.

The base cover 150 receives oil in the clearance between it and the sleeve 120 to serve as a bearing supporting the bottom surface of the shaft 110.

The thrust plate 130 is disposed upward in the shaft direction of the sleeve 120 and is combined with the shaft 110. The center of the thrust plate 110 includes a hole corresponding to the cross section thereof. The shaft 110 may be inserted into the hole.

In this configuration, the thrust plate 130 may be manufactured separately to be combined with the shaft 110, but may be integrally formed with the shaft 110 from the beginning of manufacturing and may be rotated along the shaft 110 at the time of the rotary motion of the shaft 110.

In addition, the thrust plate 130 may serve to prevent the rotating members 300 from floating due to the interference with the cap member 140 to be described below. In this connection, the thrust plate 130 may be functionally referred to as an anti-floating part 130.

The top surface of the thrust plate 130 may be provided with a thrust dynamic groove providing a thrust dynamic groove to the shaft 110.

The thrust dynamic groove is not limited to the case in which it is formed on the top surface of the thrust plate 130 as described above. As a result, the thrust dynamic groove may also be formed on the top surface of the sleeve 120 corresponding to the bottom surface of the thrust plate 130.

Further, the thrust plate 130 may form a leakage preventing gap 160 and an oil sealing gap 170 between it and the cap member 140 to be described below, which will be described below in detail.

The cap member 140 is a member that is combined with the sleeve at the top side of the thrust plate 130 to seal oil between the cap member 140 and the thrust plate 130. The top surface of the sleeve 120 is provided with a groove stepped in an inner-diameter direction to be press-fitted in the sleeve 120, such that the cap member 140 may inserted into the stepped groove.

Although not shown, the cap member 140 is provided with a circumferential groove in an outer-diameter direction to be press-fitted in the thrust plate 130 and the sleeve 120, such that it may be inserted into the outer peripheral surface of the sleeve 120.

In addition, the cap member 140 serves to prevent the rotating member 300 from floating in connection with the thrust plate 130, which may be referred to a stopper part 140. Functionally, the anti-floating part 130 and the stopper part 140 may be reversely acted to each other.

In this case, the micro clearance between the cap member 140 and the thrust plate 130 may be filled with oil and may be provided with the leakage preventing gap 160 in order to prevent the oil from being leaked to the outside.

That is, the cap member 140 may include the protruded leakage preventing part 145 to form the leakage preventing gap 160 and the leakage preventing part 145 may minimize the gap between the thrust plate 130 and the cap member 140.

In other words, the cap member 140 is the fixing member 200 fixed to the sleeve 120 and the thrust plate 130 is the rotating member 300 fixing to the rotating shaft 110, such that the leakage preventing gap 160 may be formed between the rotating member 300 and the fixing member 200.

In addition, described functionally, the leakage preventing gap 160 may be formed between the stopper part 140 and the anti-floating part 130.

Therefore, it is to be noted that the cap member 140 and the thrust plate 130 can each be substituted into the stopper part 140 and the anti-floating part 130, and vice versa.

The leakage preventing gap 160 and the oil sealing gap 170 continued to the leakage preventing gap 160 may be formed between the fixing member 200 and the rotating member 300.

The oil sealing gap 170 may have a larger gap than that of the leakage preventing gap 160 and may form the interface of oil.

Similar to the leakage preventing gap 160, the oil sealing gap 170 may be formed between the fixing member 200 and the rotating member 300. Strictly speaking, the oil sealing gap 170 may be formed between the top surface of the thrust plate 130 and the bottom surface of the cap member 140.

In addition, as described above, in order to make the oil sealing gap 170 larger than the leakage preventing gap 160, a portion of the bottom surface of the cap member 140 may be provided with the protruded leakage preventing part 145.

In this configuration, the cap member 140 means the fixing member 200. The leakage preventing part 145 may be formed by protruding a portion of the bottom surface of the fixing member 200 forming the leakage preventing gap 160.

In order to form the leakage preventing gap 160, when a portion of the bottom surface of the fixing member 200 is formed to be protruded, the protruded bottom surface thereof may be flat and the bottom surface of the fixing member 200 forming the oil sealing gap 170 may be similarly flat.

In other words, one surface of the cap member 140 formed with the leakage preventing part 145 may mean a plane stepped in the interfacial direction of oil from one end of the leakage preventing part 145.

Numerically, the difference α between the leakage preventing gap 160 and the oil sealing gap 170 may be in the range of exceeding 0 μm to 30 μm or less.

However, it is to be noted that the difference α between the gaps is not limited thereto and therefore, may be changed by those skilled in the art according to need.

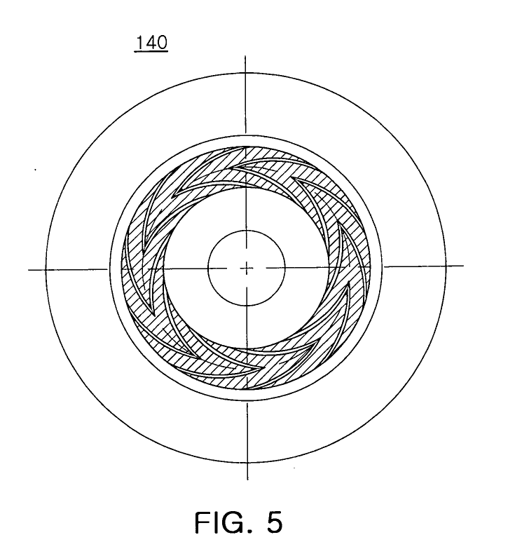

In addition, a pumping groove 180 pumping the oil from the interface of oil toward the leakage preventing part 145 may be formed between the interface of oil and the leakage preventing part 145 on one surface of the cap member 140 forming the oil sealing gap 170, i.e., one surface of the cap member 140 formed with the leakage preventing part 145. The pumping groove 180 will be described below with reference to FIGS. 4 and 5.

Referring to FIG. 3, the bottom surface of the cap member 140 forming the leakage preventing gap 160 is protruded, such that it may include the leakage preventing part 145, similar to the exemplary embodiment of the present invention.

However, there is a difference in that the bottom surface of the cap member 140 forming the oil sealing gap 170 is formed to be tapered.

In other words, one surface of the cap member 140 formed with the leakage preventing part 145 may be formed to be tapered to have the oil sealing gap increased from one end of the leakage preventing part 145 toward the interfacial direction of the oil.

In this case, an angle β in which the bottom surface of the cap member 140 forming the oil sealing gap 170 is tapered upward in a shaft direction may be in the range of 1° or more to 10° or less.

In other words, this may mean that the bottom surface of the fixing member 200, the cap member 140 may be tapered upward in a shaft direction.

In addition, a pumping groove 180 pumping the oil from the interface of oil toward the leakage preventing part 145 may be formed between the interface of oil and the leakage preventing part 145 on one surface of the cap member 140 forming the oil sealing gap 170, i.e., one surface of the cap member 140 formed with the leakage preventing part 145. The pumping groove 180 will be described below with reference to FIGS. 4 and 5.

In this configuration, comprehensively considering the leakage preventing gap 160 and the oil sealing gap 170 formed by one component of the cap member 140, i.e., the leakage preventing part 145, the micro clearance between the cap member 140 and the thrust plate 130 includes only the leakage preventing gap 160 formed by the leakage preventing part 145 and the oil sealing gap 170 larger than the leakage preventing gap 160, thereby making it possible to prevent the rotating member 300 from over-floating. As a result, the performance in impact resistance and vibration resistance is improved the current for driving the motor can be reduced.

In other words, the pumping groove 180 is formed on one surface of the fixing member 200 or the rotating member 300 forming the oil sealing gap 170 having a larger gap, such that the oil pumping force is not large, thereby making it possible to prevent the rotating member 300 from over-floating. As a result, the above-mentioned effects can be achieved.

In other words, the pumping groove 180 is formed on one surface of the cap member 140 forming the oil sealing gap 170, thereby making it possible to prevent the rotating member 300 from over-floating.

The foregoing exemplary embodiments describe that the leakage preventing part 145 forming the leakage preventing gap 160 is formed on the cap member 140, that is, the fixing member 200. On the contrary, it is to be noted that the leakage preventing part 145 may be formed on the thrust plate 130, that is, the rotating member 300.

FIGS. 4 and 5 are schematic bottom views of the cap member for showing the pumping groove of the cap member provided in the motor according to the exemplary embodiment of the present invention.

Referring to FIGS. 4 and 5, the bottom surface of the cap member 140 may be consecutively provided with spiral grooves or herringbone grooves.

In this case, the cap member 140 is configured to be included in the fixing member 200 and the pumping groove 180 may thus be formed on one surface of the fixing member 200. As a result, the pumping may be made into the motor without leaking oil to the outside through the pumping groove 180 due to the impact or the vibration.

Meanwhile, the pumping groove 180 is not limited to the spiral shape or the herringbone shape. Therefore, any shape can be used if the oil forming the oil interface can be pumped into the motor at the time of the driving of the motor.

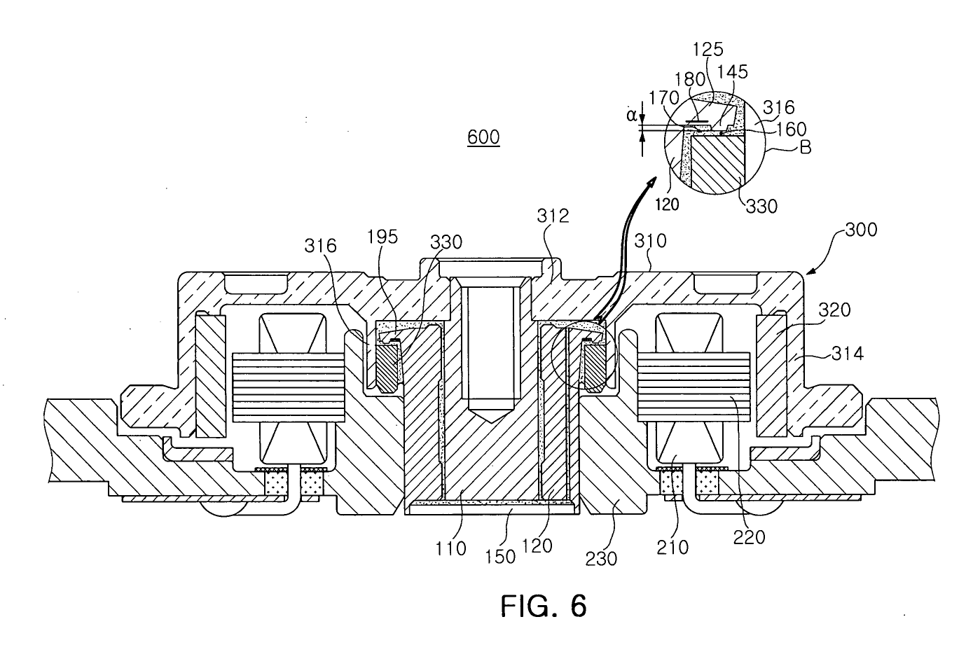

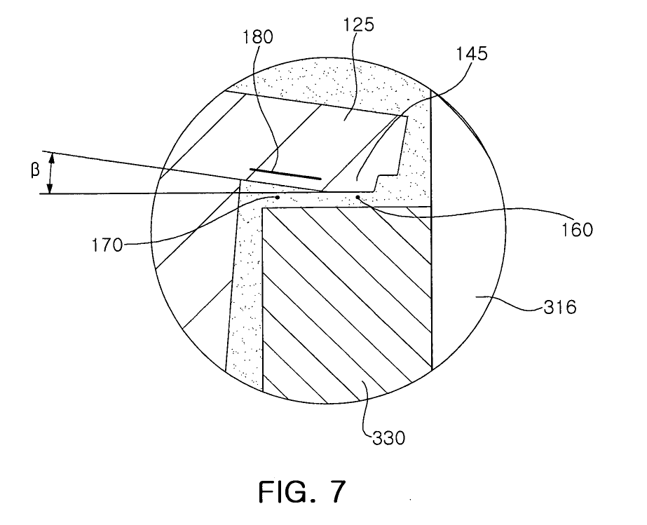

FIG. 6 is a cross-sectional view schematically showing the motor according to another exemplary embodiment of the present invention and FIG. 7 is an enlarged view of B of FIG. 6 according to another exemplary embodiment.

Referring to FIG. 6, in a motor 600 according to another exemplary embodiment of the present invention, the oil interface may be formed between one surface of a sleeve 120 supporting the shaft 110 and one surface of a stopper part 330 attached to a main wall part 316.

In this configuration, the stopper part 330 may mean the rotating member, i.e., a member serving to prevent the rotating member 300 including the shaft 110 and the rotor case 310 from over-floating.

The end of the sleeve 120 may include the anti-floating part 125 formed to be extended in an outer-diameter direction in order to correspond to the stopper part 330. The anti-floating part 125 can prevent the rotating member 300 from over-floating.

In other words, the oil may be filled between the anti-floating part 125 and the stopper part 330 and the oil preventing gap 160 for preventing the oil from being leaked to the outside may be formed therebetween.

Since the anti-floating part 125 is one component of the sleeve 120, i.e., the fixing member 200, the stopper part 330 is one component combined with the rotor case 310, that is, the rotating member 300, it may be said that the leakage preventing gap 160 is formed between the rotating member 300 and the fixing member 200.

Further, the leakage preventing gap 160 and the oil sealing gap 170 continued to the leakage preventing gap 160 may be formed between the fixing member 200 and the rotating member 300.

The oil sealing gap 170 may have a larger gap than that of the leakage preventing gap 160 and may form the oil interface.

In addition, in order to make the oil sealing gap 170 larger than the leakage preventing gap 160, a portion of the bottom surface of the anti-floating part 125 may be provided with the protruded leakage preventing part 145.

In this configuration, the anti-floating part 125 means the fixing member 200. The leakage preventing part 145 may be formed by protruding a portion of the bottom surface of the fixing member 200 forming the leakage preventing gap 160.

In order to form the leakage preventing gap 160, when a portion of the bottom surface of the anti-floating part 125 is formed to be protruded, the protruded bottom surface thereof may be flat and the bottom surface of the anti-floating part 125 forming the oil sealing gap 170 may be similarly flat.

In other words, one surface of the anti-floating part 125 formed with the leakage preventing part 145 may mean a plane stepped in the interfacial direction of the oil from one end of the leakage preventing part 145.

Numerically, the difference α between the leakage preventing gap 160 and the oil sealing gap 170 may be in the range of exceeding 0 μm to 30 μm or less.

However, it is to be noted that the difference α between the gaps is not limited thereto and therefore, may be changed by those skilled in the art.

In addition, although the foregoing exemplary embodiments describe that the anti-floating part 125 is formed on the sleeve 120 and the stopper part 330 is formed on the main wall part 316, it is to be noted that the anti-floating part 125 and the stopper part 330 may be reversely acted to each other.

The pumping groove 180 for pumping oil may be formed on at least one of one surface of the stopper part 330 or one surface of the anti-floating part 125 forming the oil sealing gap 170. The pumping groove 180 may be any one of the spiral shape or the herringbone shape.

In other words, the pumping groove 180 pumping oil from the oil interface toward the leakage preventing part 145 may be formed between the oil interface and the leakage preventing part 145 on the anti-floating part 125 formed with the leakage preventing part 145.

Referring to FIG. 7, similar to the exemplary embodiments, one surface of the sleeve 120 forming the leakage preventing gap 160 is protruded. However, the configuration and effect of the present exemplary embodiment is the same as the foregoing exemplary embodiments except that one surface of the anti-floating part 125 forming the oil sealing gap 170 is tapered.

In other words, one surface of the anti-floating part 125 formed with the leakage preventing part 145 may be formed to be tapered to have the oil sealing gap increased from one end of the leakage preventing part 145 toward the interfacial direction of the oil.

In this case, an angle β in which one surface of the anti-floating part 125 forming the oil sealing gap 170 is tapered upward in a shaft direction may be in the range of 1° or more to 10° or less.

In other words, this may mean that the bottom surface of the fixing member 200, the anti-floating part 125 may be tapered upward in a shaft direction.

As described above, the over-floating of the rotating member 300 can be prevented by the leakage preventing gap 160 and the oil sealing gap 170 formed between the rotating member 300 and the fixing member 200 and between the anti-floating parts 125 and 130 and the stopper parts 140 and 330 of the motors 400, 500, and 600. As a result, the impact resistance and the vibration resistance can be improved and the current for driving the motor can be reduced.

In other words, the pumping groove 180 is formed on one surface of the fixing member 200 or the rotating member 300 forming the oil sealing gap 170 having a larger gap than that of the leakage preventing gap 160, such that the oil pumping force is not large, thereby making it possible to prevent the rotating member 300 from over-floating. As a result, the above-mentioned effects can be achieved.

As set forth above, the present invention can drive the motor with the improved impact resistance and vibration resistance while being driven with low current.

In addition, the present invention can control the oil-sealed gap between the rotating member and the fixing member or between the stopper part and the anti-floating part to prevent the rotating member from over-floating, thereby making it possible to minimize the loss during the driving of the motor.

While the present invention has been shown and described in connection with the exemplary embodiments, it will be apparent to those skilled in the art that modification and variation can be made without departing from the spirit and scope of the invention as defined by the appended claims.

What is claimed is:

1. A motor, comprising:
a fixing member inserted with a shaft and supporting the rotation of the shaft;
a rotating member rotating while interworking with the shaft;
a stopper part formed on one of the fixing member and the rotating member to prevent the rotating member from floating;
an anti-floating part formed on the other one of the fixing member and the rotating member and interfering with the stopper part to prevent the rotating member from floating; and
a leakage preventing part sealing oil between the stopper part and the anti-floating part and formed to be protruded on at least one of the stopper part and the anti-floating part to minimize an oil sealing gap between the stopper part and the anti-floating part.

2. The motor of claim 1, wherein one surface of the stopper part or the anti-floating part formed with the leakage preventing part is a plane stepped from one end of the leakage preventing part toward the interfacial direction of oil.

3. The motor of claim 1, wherein one surface of the stopper part or the anti-floating part formed with the leakage preventing part is formed to be tapered to include the oil sealing gap increased from one end of the leakage preventing part toward the interfacial direction of oil.

4. The motor of claim 1, wherein a pumping groove pumping the oil from the oil interface toward the leakage preventing part is formed between the oil interface and the leakage preventing part on one surface of the stopper part or the anti-floating part formed with the leakage preventing part.

5. The motor of claim 4, wherein the pumping groove is formed in at least one of a spiral shape or a herringbone shape.

6. A motor, comprising:
a sleeve supporting a shaft to protrude the top end of the shaft upward in a shaft direction;
a rotating member rotating, while interworking with the shaft;
a thrust plate combined with the shaft protruded upward in the shaft direction of the sleeve to provide a thrust dynamic pressure;
a cap member combined with the sleeve on the top portion of the thrust plate to seal oil between the cap member and the thrust plate; and
a leakage preventing part sealing oil between the thrust plate and the cap member and formed to be protruded on at least one of the thrust plate and the cap member to minimize the oil sealing gap between the thrust plate and the cap member.

7. The motor of claim 6, wherein one surface of the thrust plate or the cap member formed with the leakage preventing part is a plane stepped from one end of the leakage preventing part toward the interfacial direction of oil.

8. The motor of claim 6, wherein one surface of the thrust plate or the cap member formed with the leakage preventing part is formed to be tapered to include the oil sealing gap increased from one end of the leakage preventing part toward the interfacial direction of oil.

9. The motor of claim 6, wherein a pumping groove pumping the oil from the oil interface toward the leakage preventing part is formed between the oil interface and the leakage preventing part on one surface of the thrust plate or the cap member formed with the leakage preventing part.

10. The motor of claim 9, wherein the pumping groove is formed in at least one of a spiral shape or a herringbone shape.
